(19) United States
(12) Patent Application Publication
(10) Pub. No.: US 2009/0202658 A1
(43) Pub. Date: Aug. 13, 2009

(54) Versatile antimicrobial agent and uses thereof

(76) Inventor: Raul G. Cuero, Cypress, TX (US)

Correspondence Address: BAKER BOTTS L.L.P., 2001 ROSS AVENUE, SUITE 600, DALLAS, TX, 75201-2980, US

(21) Appl. No.: 12/288,818

(22) Filed: Oct. 23, 2008

Related U.S. Application Data
(60) Provisional application No. 61/065,034, filed on Feb. 8, 2008.

(51) Int. Cl. A01N 59/16; A01P 1/00; A01P 3/00

(52) U.S. Cl. 424/641

(57) ABSTRACT

The present disclosure relates, according to some embodiments, to antimicrobial agents comprising nitric acid, tetraethylorthosilicate, tetraethyl phosphate, zinc nitrate, and gallium nitrate. Antimicrobial agents may also include borane-tert-butylamine. Antimicrobial agents restrict and/or prevent the growth of at least one bacteria and/or at least one fungus. Bacteria may include, for example, Actinomyetes (e.g., Nocardia), Salmonella, Escherichia, Staphylococcus (e.g., Staphylococcus Aureus), Enterobacter (e.g., Enterobacter aerogenes), and/or Bacillus. Fungi may include, for example, Stachybotrys, Fusarium, Aspergillus (e.g., Aspergillus flavus), Penicillium, Candida (e.g., Candida albicans), Paracoccidiodes, and/or Trycophyton.

### CROSS REFERENCE TO RELATED APPLICATIONS

This application claims the benefit of U.S. Provisional Application Ser. No. 61/065,034 filed Feb. 8, 2008, the contents of which is hereby incorporated by reference in its entirety.

### FIELD OF THE DISCLOSURE

The present disclosure, according to some embodiments, relates to an agent with antifungal and/or antibacterial properties. According to other embodiments, it relates to use of such an agent to control fungal and/or bacterial growth.

### BACKGROUND

An antimicrobial agent may often be expensive, undesirably toxic, and/or ineffective (e.g., due to acquired resistance). In addition, an antimicrobial agent may often be effective for controlling bacterial or fungal growth, but not for both.

### SUMMARY

Therefore, a need has arisen for antimicrobial agents that are less expensive, less toxic, and/or more effective. In addition, a need has arisen for antimicrobial agents that are effective for controlling both bacterial and fungal growth.

According to some embodiments, the present disclosure relates to an antimicrobial agent that may include, without limitation, nitric acid, tetraethylorthosilicate (TEOS), tetraethyl phosphate (TEPS), zinc nitrate and gallium nitrate. In some embodiments, an antimicrobial agent may comprise borane-tert-butylamine. The amounts of each component may be sufficient (individually and/or collectively) to restrict and/or prevent growth of at least one bacteria and/or at least one fungus. For example, an antimicrobial agent may comprise 97% borane-tert-butylamine in an amount of from about 1.5 g to 7 g per liter. For example, an antimicrobial agent may comprise 3 molar nitric acid in an amount of from about 3 mL to about 30 mL per liter of antimicrobial agent (i.e., from about 9 mM to about 90 mM). For example, an antimicrobial agent may comprise 98% (W/V) or (V/V) tetraethylorthosilicate in an amount of from about 6.75 mL to about 13.3 mL per liter of antimicrobial agent (i.e., from about 0.66% to about 1.3% (W/V) or (V/V)). For example, an antimicrobial agent may comprise tetraethyl phosphate in an amount of from about 0.45 g to about 0.9 g per liter. For example, an antimicrobial agent may comprise zinc nitrate in an amount of from about 0.75 g to about 1.45 g per liter. For example, an antimicrobial agent may comprise gallium nitrate in an amount of from about 0.95 g to about 1.9 g per liter. An antimicrobial agent may comprise, according to some embodiments, a solvent selected from the group consisting of water, alcohol, and combinations thereof.

The present disclosure relates, according to some embodiments, to a method of restricting and/or preventing bacterial growth comprising exposing the bacteria to an antimicrobial agent (e.g., comprising nitric acid, TEOS, TEPS, zinc nitrate, and/or gallium nitrate), wherein the antimicrobial agent restricts or prevents the growth of the bacteria. The bacteria, in some embodiments, may be selected from the group consisting of Actinomycetes, Nocardia, Salmonella, Staphylococcus (e.g., Staphylococcus Aureus), Enterobacter (e.g., Enterobacter aerogenes), Escherichia, and Bacillus. A method of restricting and/or preventing bacterial growth may comprise coating an article with the antimicrobial agent prior to exposing the bacteria to the antimicrobial agent, in some embodiments. A method of restricting and/or preventing bacterial growth may comprise, according to some embodiments, permeating an article with the antimicrobial agent prior to exposing the bacteria to the antimicrobial agent.

The present disclosure relates, according to some embodiments, to a method of restricting and/or preventing fungal growth comprising exposing the fungus to an antimicrobial agent (e.g., comprising nitric acid, TEOS, TEPS, zinc nitrate, and/or gallium nitrate), wherein the antimicrobial agent restricts or prevents the growth of the fungus. The fungus, in some embodiments, may be selected from the group consisting of: Stachybotrys, Penicillium, Fusarium, Aspergillus (e.g., Aspergillus flavus), Candida (e.g., Candida albicans), Paracoccidiodes, and Trycophyton. A method of restricting and/or preventing fungal growth may comprise coating an article with the antimicrobial agent prior to exposing the fungus to the antimicrobial agent, in some embodiments. A method of restricting and/or preventing fungal growth may comprise, according to some embodiments, permeating an article with the antimicrobial agent prior to exposing the fungus to the antimicrobial agent.

The present disclosure, in some embodiments, relates to antimicrobial articles of manufacture (e.g., comprising nitric acid, TEOS, TEPS, zinc nitrate, and/or gallium nitrate), wherein the nitric acid, the TEOS, the TEPS, the zinc nitrate, and the gallium nitrate are present in amounts sufficient to restrict or prevent the growth of at least one bacteria and/or at least one fungus. For example, an article of manufacture may include a container, a cutting board, a sponge, a fabric, a garment, a handle, a toy, a floor tile, an ointment, and a wound dressing.

The present disclosure, in some embodiments, relates to a method of restricting and/or preventing fungal growth on a seed comprising contacting the seed with an antimicrobial agent (e.g., comprising nitric acid, TEOS, TEPS, zinc nitrate, gallium nitrate, and/or borane-tert-butylamine (optional)), the antimicrobial agent restricts or prevents the growth of the fungus. According to some embodiments, a method may include restricting and/or preventing fungal growth on the seed of a plant selected from the group consisting of barley, corn, wheat, oat, bean, soybean, pea, alfalfa, and peanut. A method may further comprise coating (e.g., spraying) the antimicrobial agent on the seed, in some embodiments. A method may further comprise, according to some embodiments, dipping the seed into the antimicrobial agent.

The present disclosure also relates, in some embodiments, to a method of making an antimicrobial article. For example, a method of making an antimicrobial article may comprise combining nitric acid, tetraethylorthosilicate, tetraethyl phosphate, zinc nitrate, gallium nitrate, and a solvent to form a solution, mixing the solution under conditions that permit formation of a gel, molding the gel into the shape of the article, and dehydrating (e.g., lyophilizing and/or firing) the gel to form the antimicrobial article. A method of making an antimicrobial article may further comprise adding borane-tert-butylamine to the solution, in some embodiments. A solvent for making an antimicrobial article may be selected, according to some embodiments, from the group consisting of water, alcohol, and combinations thereof.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the disclosure may be understood by referring, in part, to the present disclosure and the accompanying drawings, wherein:

FIG. 1A is a photograph illustrating Enterobacter aerogenes growth on agar plates without antimicrobial agent;

FIG. 1B is a photograph illustrating Enterobacter aerogenes growth on agar plates with antimicrobial agent B, according to a specific example embodiment of the disclosure;

FIG. 2A is a photograph illustrating Staphylococcus aureus growth on agar plates without antimicrobial agent;

FIG. 2B is a photograph illustrating Staphylococcus aureus growth on agar plates with antimicrobial agent B, according to a specific example embodiment of the disclosure;

FIG. 3A is a photograph illustrating Candida albicans growth on agar plates without antimicrobial agent;

FIG. 3B is a photograph illustrating Candida albicans growth on agar plates with antimicrobial agent A, according to a specific example embodiment of the disclosure;

FIG. 4A is a photograph illustrating Aspergillus flavus growth on agar plates without antimicrobial agent;

FIG. 4B is a photograph illustrating Aspergillus flavus growth on agar plates with antimicrobial agent A, according to a specific example embodiment of the disclosure;

FIG. 5A is a photograph illustrating Aspergillus flavus growth on corn kernels without antimicrobial agent;

FIG. 5B is a photograph illustrating Aspergillus flavus growth on corn kernels with antimicrobial agent A, according to a specific example embodiment of the disclosure;

FIG. 5C is a photograph illustrating Aspergillus flavus growth on corn kernels with antimicrobial agent B, according to a specific example embodiment of the disclosure;

FIG. 6A is a photograph illustrating Aspergillus flavus growth on corn kernels without antimicrobial agent;

FIG. 6B is a photograph illustrating Aspergillus flavus growth on corn kernels with antimicrobial agent A, according to a specific example embodiment of the disclosure;

FIG. 6C is a photograph illustrating Aspergillus flavus growth on corn kernels with antimicrobial agent B, according to a specific example embodiment of the disclosure;

FIG. 7A is a photograph illustrating Aspergillus flavus growth on agar plates without antimicrobial agent;

FIG. 7B is a photograph illustrating Aspergillus flavus growth on agar plates with antimicrobial agent A, according to a specific example embodiment of the disclosure; and

FIG. 7C is a photograph illustrating Aspergillus flavus growth on agar plates with antimicrobial agent B, according to a specific example embodiment of the disclosure.

### DETAILED DESCRIPTION

The present disclosure relates, in some embodiments, to antimicrobial compositions and/or materials comprising, for example, a nitrate, borane, gallium, tetraethylorthosilicate (TEOS), and/or tetraethyl phosphate (TEPS).

An antimicrobial agent may restrict and/or prevent growth of molds and/or bacteria in a liquid or on a surface in some embodiments. Methods and compositions of the disclosure, in some embodiments, may reduce or prevent growth of one or more microbes. Examples of microbes may include, without limitation, Stachybotrys, Fusarium, Penicillium, Aspergillus (e.g., Aspergillus fumigatus), Candida, Actinomycetes (e.g., Nocardia), Paracoccidiodes, Trycophyton, Salmonella, Staphylococcus, Enterobacter, Escherichia, Bacillus, and combinations thereof). An antimicrobial agent of the disclosure may be formed, in some embodiments, by a sol-gel process (e.g., forming a solution, mixing and/or dehydrating to form a gel, and/or firing to form a porous material).

In some embodiments, zinc, aluminum, silver, chlorine, hypochlorites, ammonium compounds, alcohol, phenols, peroxides, and/or ozone may be included in an antimicrobial agent and may convey at least one antimicrobial property. However, in some embodiments, these compounds may be regarded as undesirably expensive, toxic, and/or environmentally destructive. In addition, a microbe may be regarded as actually or potentially resistant to one or more of these compounds (e.g., due to overuse of the compound). Therefore, in some embodiments, a composition of the disclosure may exclude zinc, aluminum, silver, chlorine, hypochlorites, ammonium compounds, alcohol, phenols, peroxides, and/or ozone.

Compositions in accordance with some embodiments, may be regarded as versatile for having both antibacterial activity and antifungal activity. In some embodiments, it may be desirable and/or required to configure compositions for use on solid surfaces and in liquids. Compositions in accordance with some embodiments, may be regarded as cost effective (e.g., where one or more active ingredients are potent and naturally-occurring compounds). According to some embodiments, antimicrobial agents may be easy to apply. For example, sol-gel processing may allow the antimicrobial agent to be coated onto a surface or produced in powder form for addition to liquids. In addition, a dried form may be reconstituted to desired thickness.

In some embodiments, an antimicrobial agent may be or may include an agent, such as a glass-ceramic that has surface-reactive properties. For example, an antimicrobial agent may include, without limitation, nitric acid, tetraethylorthosilicate (TEOS), tetraethyl phosphate (TEPS), zinc nitrate and gallium nitrate. According to a further embodiment, this agent may also include borate-tert-butylamine. The agent may be provided as a liquid, sol-gel or dried form. It may be adjusted to have the desired thickness for a particular use.

In some specific example embodiments, an antimicrobial agent may contain the materials shown in Table 1 in the specified amounts.

TABLE 1

| | |
|---|---|
| From about 3 mL to 30 mL | Nitric Acid (3 M) |
| From about 6.75 mL to about 13.3 mL | TEOS (98%) |
| From about 0.45 g to about 0.9 g | TEPS |
| From about 0.75 g to about 1.45 g | Zinc Nitrate |
| From about 0.95 g to about 1.9 g | Gallium Nitrate |
| Remainder of volume | Water |
| Total Volume* | 1 L |

*Amounts of each material may be adjusted as appropriate for a total volume of 1 L.

In another specific embodiment, a composition may include the materials shown in Table 1 in the specified amounts.

TABLE 2

| | |
|---|---|
| From about 3 mL to 30 mL (v/v) | Nitric Acid (3 M) |
| From about 6.75 mL to about 13.3 mL | TEOS (98%) |
| From about 0.45 g to about 0.9 g | TEPS |
| From about 0.75 g to about 1.45 g | Zinc Nitrate |
| From about 1.5 g to 7 g | Borane-tert- |
| | butylamine (97%) |
| From about 0.95 g to about 1.9 g | Gallium Nitrate |
| Remainder of volume | Water |
| Total Volume* | 1 L |

*Amounts of each material may be adjusted as appropriate for a total volume of 1 L.

The above antimicrobial agents may be a final form of the antimicrobial agent used in a particular application, or they may be an initial form before use in an application and may be subject to further changes. For example, an antimicrobial agent may be dried or diluted, resulting in a loss or gain of water content. The viscosity of the agent may be adjusted as desired or required for particular uses. For example, it may be in a more liquid, less viscous, form to better penetrate surfaces, or in a more viscous gel form to coat them. It may also be added to other compositions, such as liquids or gels, particularly if it has been previously dried. In some embodiments, the pH antimicrobial agents (e.g., as set forth in Tables 1 and 2) may be adjusted as desired or required. For example, a desired pH may be achieved by combining specified amounts of acid(s), base(s), and/or buffer(s) in the agent (e.g., during formulation). A desired pH may be achieved by titrating the antimicrobial agent with an acid or base until the desired pH is reached.

Without limiting the disclosure to any particular mechanism of action, components of an antimicrobial agent may have one or more identifiable functions. Each identifiable function may be performed in some contexts, but not necessarily all contexts. Each identifiable function may be dependent on, independent of, and/or interdependent on the absence, presence, and/or concentration of one or more other components. It may desirable and/or required to include a particular component (or combination of components) at a particular concentration (or combination of concentrations), according to some embodiments. In some embodiments, identifying an actual or potential function of a component does not necessarily preclude alternate and/or additional functions.

TEOS is a silicate which provides, according to some embodiments, the basic solid molecular structure of the antimicrobial agent. If the composition is intended primarily for anti-bacterial use, smaller amounts of TEOS may be effective.

TEPS helps with solubility and other functions of other components, in some embodiments. If the agent is intended primarily for anti-bacterial use, smaller amounts of TEPS may be effective.

According to some embodiments, nitric acid helps other components of the agent dissolve when the agent is being made. Nitric acid is particularly compatible with other ingredients including zinc nitrate and gallium nitrate. Although 3M nitric acid is used in the embodiment described in Tables 1 and 2 above, other concentrations of nitric acid, such as between 1M and 3M, may be used with appropriate adjustments to the volume to reflect changes in concentration. Further, smaller amounts of nitric acid may be used in embodiments containing less of the components it assists to dissolve, such as zinc nitrate and gallium nitrate.

Gallium nitrate, according to some embodiments, may be the component primarily responsible for the antibacterial and antifungal effects of the antimicrobial agents. According to some embodiments, it is also useful because it dissolves well in both water and alcohol and/or because it is compatible with both zinc nitrate and nitric acid. If the agent is intended primarily for anti-bacterial use, smaller amounts of gallium nitrate may be effective.

Zinc nitrate enhances, according to some embodiments, the antimicrobial properties of both gallium and borane (in agent in which borane is present). If the agent is intended primarily for anti-bacterial use, smaller amounts of zinc nitrate may be effective.

According to some embodiments, borane-tert-butylamine (also referred to as “borane”) enhances the anti-bacterial properties of antimicrobial agent containing it. It may also enhance anti-fungal properties. It is also compatible with the other components and is soluble in both alcohol and water.

Water in the above agent serves as a solvent. It may be replaced (e.g., partially, completely) with other compatible solvents, such as alcohol, particularly ethanol.

One skilled in the art will be able to determine appropriate changes to the antimicrobial agent components, for example, adjustments in amount of materials added if different molarities or other concentration factors of components are used. Using the above descriptions of the functions of antimicrobial agent components as well as other information, one skilled in the art may determine suitable substitutes for some components, such as, for example, nitric acid.

An antimicrobial agent may include, in some embodiments, aluminum, silver, chlorine, one or more hypochlorites, one or more ammonium compounds, one or more alcohols, one or more phenols, one or more peroxides, ozone, and combinations thereof.

A composition of the disclosure may, in some embodiments, display measurable antimicrobial activity within about 30 seconds to about 24 hours of contact with a microbe. The time required for measurable antimicrobial activity may depend on microbial population load and/or environmental conditions (e.g., temperature, pH, available nutrients). The time required for measurable antimicrobial activity may depend on the metric used. Antimicrobial activity metrics may include, for example, growth rate, number of microbes present, rate of cell division, rate of cell death, cellular integrity, accumulation and/or decay of a marker (e.g., antigen, toxin) metabolic activity, genetic activity (e.g., transcription and/or translation), and the like. As one of ordinary skill in the art will appreciate in light of the instant disclosure, the amount and composition of an antimicrobial agent used for a particular purpose may be adjusted to achieve a desired antimicrobial activity.

Some embodiments of the present disclosure relate to an antimicrobial agent with antibacterial and/or antifungal properties. Therefore an antimicrobial agent, in some embodiments, may be used to restrict (e.g., reduce, control, limit, inhibit, slow) and/or prevent (e.g., arrest, block, prevent) fungal and/or bacterial growth. In some embodiments, an antimicrobial agent may be used as a bactericide and/or fungicide. Some example embodiments of the disclosure relate to the preparation of an antimicrobial agent material by sol-gel processing to produce gels or powders that may be used to limit or prevent microbial growth on surfaces and/or in liquids. The antimicrobial agent, when in a gel or other liquid or semi-liquid state, may be used to coat a solid surface to prevent microbial growth on the surface or within the surface to which the coating is applied. In some embodiments, a surface that may be contacted and/or coated with an antimicrobial agent may include, without limitation, wood, concrete, agent, carpet, rug, skin, and/or a tooth. The antimicrobial agent may also be used to form objects with antibacterial and antifungal properties (e.g., containers, cutting boards, sponges, fabrics, garments, handles, toys, floor tiles, ointments, wound dressings, and the like).

An antimicrobial agent may be used to control bacterial or fungal growth in at least the following industries and products: trash and other collection, processing and recycling (e.g. as a coating for trash cans); human waste processing; medical facilities, appliances, and supplies (e.g., before and/or after use); dental facilities, appliances, and supplies (e.g., before and/or after use); abbatoir facilities, appliances, and supplies (e.g., before and/or after use); textiles, such as carpeting; detergents and soaps, such as rug, carpet, and textile cleaners; sanitizers; cleansers; sterilizers; disinfectants; deodorizers; food service industries, particularly in safety applications; deck and fence cleaners and preservatives; coatings and paints; mold, mildew and stain removal products; laundry industry and products; agricultural product applications (e.g., a harvest and/or post-harvest treatment and/or coating for apples, bananas, grapes, and or other plant products); water treatment including crop irrigation water; seed and grain treatments; materials and construction applications (e.g., a coating and/or treatment of construction materials and/or sites); marine antimicrobial applications; pest management and insect control; and/or pool and spa applications. The antimicrobial may also generally be used in place of other antibacterial and antifungal agents, such as bleach.

To reduce and/or avoid microbial growth, the addition of zinc, aluminum, silver, chlorine, hypochlorites, ammonium compounds, alcohol, phenols, peroxides, or ozone may be used to give the agent one or more antimicrobial properties. However, due to drawbacks of some of these materials, they may also be specifically excluded from the antimicrobial agent.

### EXAMPLES

The following examples are provided to illustrate some embodiments of the disclosure and are not intended to embody the total scope of the invention or any aspect thereof. Variations of the exemplary embodiments below will be apparent to one skilled in the art and are intended to be included within the scope of the invention.

### Example 1

### Preparation of Antimicrobial Agent A

An antimicrobial agent of the type found in Table 1 was prepared by mixing 30 mL of 3M Nitric acid with 13.3 mL of TEOS (98%) and stirring for 45 minutes. 0.9 g of TEPS was then added and mixed for 30-45 minutes. 1.49 g of Zinc Nitrate was added and stirred until it dissolved. Next, 1.9 g of Gallium Nitrate was added and mixed until fully dissolved. Finally, 962.1 mL of water was added to make the total volume 1 L.

### Example 2

### Preparation of Antimicrobial Agent B

An antimicrobial agent of the type found in Table 2 was prepared by mixing 30 mL of 3M Nitric acid with 13.3 mL of TEOS (98%) and stirring for 45 minutes. 0.9 g of TEPS was then added and mixed for 30-45 minutes. 1.49 g of Zinc Nitrate was added and stirred until it dissolved. Next, 7 g of borane-tert-butyl (97%) was mixed with 100 mL of ethanol then added. Next, 1.9 g of Gallium Nitrate was added and mixed until fully dissolved. Finally, 603.8 mL of water was added to make the total volume 1 L.

### Example 3

### Antibacterial Effects

The antimicrobial agents of Examples 1 and 2 (Antimicrobial agent Compositions A and B) were prepared at 10% concentration based on weight/volume.

Tests were carried out according to EPA standards for determining antimicrobial effect. Specifically, tests were carried out on glass plates of 20 cm×20 cm, which were divided into four squares of 5 cm×5 cm each. The plates were sterilized before use.

Each plate was coated with 1000 cells/mL of either Staphylococcus Aureus (ATCC 6538) or Enterobacter aerogenes (ATCC 13048). One mL of bacterial sample was used for each coating. Three plate squares were used for each bacterial strain each time. Coated plates were allowed to dry for two hours under a microbiological laminar flow, aseptically. After the two-hour drying period, the plates were sprayed with Antimicrobial Agent A or B (except for control plates.) One mL of antimicrobial agent was used for each plate. Treated plates were incubated at room temperature (approximately 27° C.) under laminar flow, aseptically.

Each square of each plate was swabbed to recover bacteria, followed by bacterial dilution, and the samples from each respective 1 mL dilution were used to pour separate agar plates, according to standard plate dilution methods. Bacterial cultures were grown on nutrient agar and observation was carried out at one hour and samples were taken and analyzed at 24 hours, 48 hours, and 72 hours after treatment.

Both antimicrobial agents inhibited bacterial growth in the agar completely. Table 3 shows the results when samples were taken from each glass plate 24 hours after treatment with antimicrobial agent. The bacterial counts were essentially the same at 48 and 72 hours.

TABLE 3

| | Colony Forming |
|---|---|
| Sample | Units +/− Standard Deviation |
| Staphylococcus aureus alone | All agar plates |
| | completely covered |
| Enterobacter aerogenes alone | 3.6 × 10⁴ +/− 0.2 |
| Staphylococcus aureus + A | 0.00 |
| Staphylococcus aureus + B | 0.00 |
| Enterobacter aerogenes + A | 0.00 |
| Enterobacter aerogenes + B | 0.00 |

Six agar plate replicates were used each time.

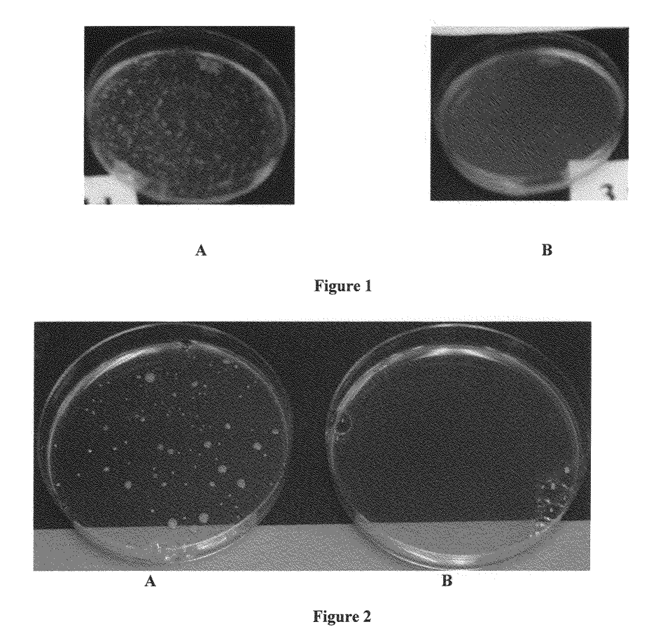

A similar experiment using antimicrobial agent B only was carried out. Samples were taken from the glass plates 1 hour and 24 hours after treatment with the antimicrobial agent. Example control and antimicrobial agent-treated samples are shown in FIGS. 1 and 2.

TABLE 4

| | Colony Forming Units +/− | |
|---|---|---|
| | Standard Deviation | |
| Sample | 1 hour | 24 hours |
| Staphylococcus | 2.1 × 10⁴ +/− 3.3 × 10³ | 1.2 × 10⁴ +/− 2.5 × 10³ |
| aureus alone | | |
| Enterobacter | 2.6 × 10⁴ +/− 3.7 × 10³ | 1.9 × 10⁴ +/− 2.4 × 10³ |
| aerogenes alone | | |
| Staphylococcus | 0.0 +/− 0.0 | 0.0 +/− 0.0 |
| aureus + B | | |
| Enterobacter | 0.0 +/− 0.0 | 0.0 +/− 0.0 |
| aerogenes + B | | |

Nine agar plate replicates were used each time.

### Example 4

### Antifungal Effects

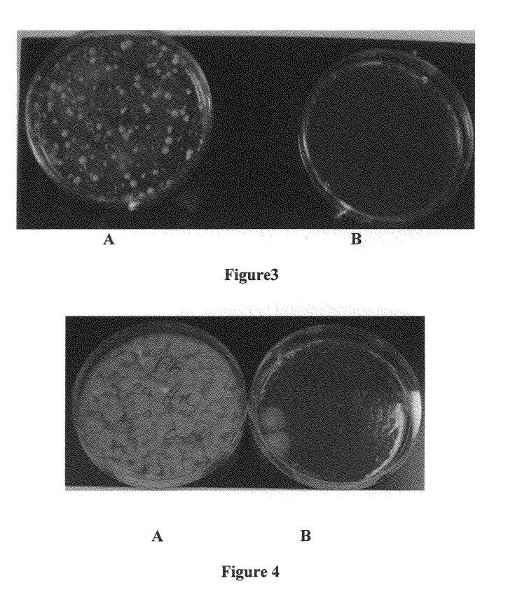

Testing similar to that of Example 3 was performed using Candida albicans (strain obtained from Texas A&M University, Biology Department) and Aspergillus flavus (SRR100-USDA). Example control and antimicrobial agent-treated samples are shown in FIGS. 3 and 4.

The A. flavus was diluted to 1×10³ and placed on glass plates as described in Example 3. Fungal samples were taken from the plates after 1 hour and used to inoculate agar plates also as described above. Colony forming units were counted after 3 days. The results are presented in Table 5.

TABLE 5

| Sample | Colony Forming Units +/− Standard Deviation |
|---|---|
| A. flavus alone | All agar plates completely covered |
| A. flavus + A | 41.7 +/− 1.62 |

Nine agar plate replicates were used each time.

The C. albicans was diluted to 1×10³ and placed on glass plates as described in Example 3. Fungal samples were taken from the plates after 1 hour and 24 hours and used to inoculate agar plates also as described above. The results are presented in Table 6.

TABLE 6

| | Colony Forming Units +/− | |
|---|---|---|
| | Standard Deviation | |
| Sample | 1 hour | 24 hours |
| C. albicans alone | 6.1 × 10² +/− 2.2 × 10² | 10.2 × 10² +/− 2.5 × 10² |
| C. albicans + A | 0.0 +/− 0.0 | 0.0 +/− 0.0 |

Nine agar plate replicates were used each time.

### Example 5

### Antifungal Effects in Corn

25 g of cracked corn kernels were placed in a 250 mL flask for each sample. The corn kernels in each flask were sterilized for 15 minutes twice at 15-20 psi and 120° C. Flasks containing the corn kernels were allowed to sit at room temperature for 1-2 hours under a microbiological laminar hood, aseptically.

Corn kernels in treated flasks were treated with 30 mL of antimicrobial agent. The kernels were swirled for 3-5 minutes, allowed to drip excess antimicrobial agent for 3-5 minutes, then allowed to sit overnight. Control kernels were treated in a similar fashion, but with 30 mL of sterilized water instead of antimicrobial agent. The following day, 1 mL of A flavus at 1×10³ spores/mL was applied to the kernels. They were then swirled for 3-5 minutes and then incubated at 26° C. Flasks were covered with a sterilized sponge stopper.

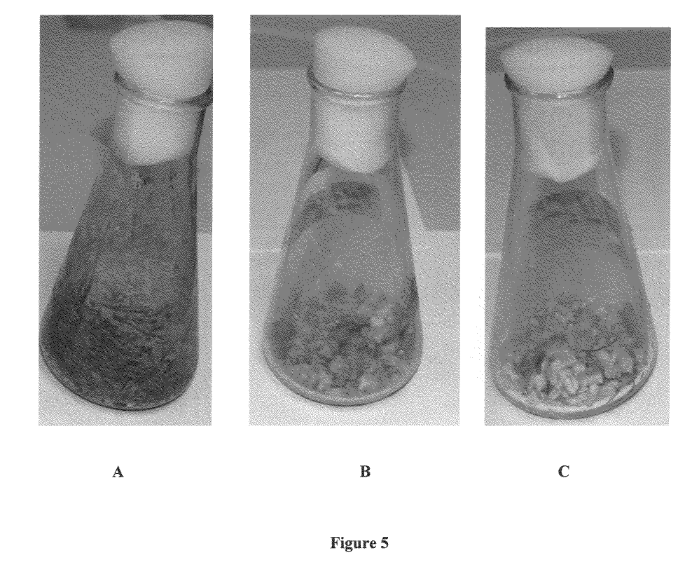

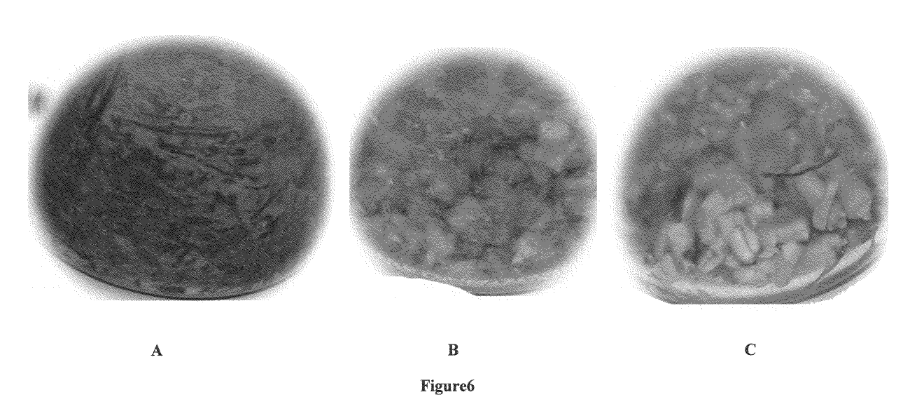

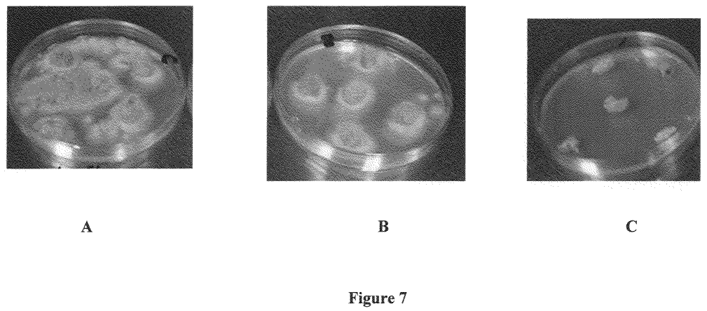

After 4 days, kernels were assessed for A. flavus growth and for Aflatoxin or fumonisin B production. Although A. flavus does not produce fumonisin B, systemic presence of Fusarium moniliforme, which resists even sterilization efforts, often results in its production. Fungal presence was assessed with the naked eye (FIGS. 5 and 6) and by placing kernels on agar plates (FIG. 7) and counting the presence of fungal colonies on the kernels, determined by percentage. Three agar plates for each test group and control group were used. Toxin levels were determined using a Neogen (Lansing, Mich.) ELISA method. Results are presented in Tables 7 and 8; concentration is expressed in parts per billion (ppb).

TABLE 7
Aflatoxin B1 Assay Results

| Sample | Toxin Concentration |
|---|---|
| Untreated kernels | 29.7 ppb |
| Untreated kernels | 30.8 ppb |
| Untreated kernels | 30.1 ppb |
| Kernels + Antimicrobial agent A | 0.0 ppb |
| Kernels + Antimicrobial agent A | 0.0 ppb |
| Kernels + Antimicrobial agent A | 0.0 ppb |
| Kernels + Antimicrobial agent B | 0.2 ppb |
| Kernels + Antimicrobial agent B | 0.0 ppb |
| Kernels + Antimicrobial agent B | 0.1 ppb |

TABLE 8
Fumonisin B Results

| Sample | Toxin Concentration |
|---|---|
| Untreated kernels | 782.4 ppb |
| Untreated kernels | 759.2 ppb |
| Untreated kernels | 753.5 ppb |
| Kernels + Antimicrobial agent A | 442.7 ppb |
| Kernels + Antimicrobial agent A | 460.8 ppb |
| Kernels + Antimicrobial agent A | 417.2 ppb |
| Kernels + Antimicrobial agent B | 188.4 ppb |
| Kernels + Antimicrobial agent B | 183.6 ppb |
| Kernels + Antimicrobial agent B | 201.9 ppb |

FIGS. 5, 6 and 7 show that both Antimicrobial agent A and Antimicrobial agent B were effective at controlling A. flavus growth. Antimicrobial agent B controlled fungal growth so well that no fungus was visible to the naked eye on the corn kernels. Antimicrobial agent A controlled growth, but not as well as Agent B. However, that data in Table 7 indicates that Antimicrobial agent A was actually better at controlling production of Aflatoxin.

This difference in ability to control fungal growth versus ability to control Aflatoxin production likely results from the fact that fungal growth and Aflatoxin production do not directly correlate. Aflatoxin is not produced at all stages of A. flavus growth. Growth of A. flavus and aflatoxin production is heterogeneous (in pockets). They are also influenced by different extrinsic factors (i.e., temperature, moisture, etc), as well as different intrinsic mechanisms of the fungus (i.e. genetics, and chemical metabolic pathways). So, it is possible that inclusion of borane in the antimicrobial agent prevents A. flavus from flourishing, but still allows some small amount of growth and also increases the amount of Aflatoxin produced or fails to control it as well as the antimicrobial agent without borane.

It is also possible that borane prevents the antimicrobial agent from permeating the corn kernels as well as antimicrobial agent without borane, such that growth of A. flavus is well controlled on the surface of the corn kernels and is not visible in FIGS. 5 and 6, but growth is less well controlled internally as shown by the higher Aflatoxin levels. Thus, in applications where it is beneficial for an antimicrobial agent to permeate a solid material, it may be beneficial to use an antimicrobial agent without borane, or to allow additional time for permeation as compared to what is needed for an antimicrobial agent without borane.

Antimicrobial agents both with and without borane were effective at controlling Fusarium moniliforme growth, as shown by the Fumonisin B production data shown in Table 8. Antimicrobial agents with borane were more effective at controlling production of this toxin.

While embodiments of this disclosure have been depicted, described, and are defined by reference to specific example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art having the benefit of this disclosure. The depicted and described embodiments of this disclosure are examples only, and are not exhaustive of the scope of the disclosure.

What is claimed is:

1. An antimicrobial agent comprising:
nitric acid;
tetraethylorthosilicate;
tetraethyl phosphate;
zinc nitrate; and
gallium nitrate,
wherein the antimicrobial agent restricts or prevents the growth of at least one fungus or bacteria.

2. An antimicrobial agent according to claim 1, wherein the antimicrobial agent restricts or prevents the growth of at least one fungus and one bacteria.

3. An antimicrobial agent according to claim 1, further comprising borane-tert-butylamine.

4. An antimicrobial agent according to claim 3 wherein the antimicrobial agent comprises 97% borane-tert-butylamine in an amount of from about 1.5 g to 7 g per liter.

5. An antimicrobial agent according to claim 1, wherein the antimicrobial agent comprises 3 molar nitric acid in an amount of from about 3 mL to about 30 mL per liter of antimicrobial agent.

6. An antimicrobial agent according to claim 1, wherein the antimicrobial agent comprises 98% tetraethylorthosilicate in an amount of from about 6.75 mL to about 13.3 mL per liter of antimicrobial agent.

7. An antimicrobial agent according to claim 1, wherein the antimicrobial agent comprises tetraethyl phosphate in an amount of from about 0.45 g to about 0.9 g per liter.

8. An antimicrobial agent according to claim 1, wherein the antimicrobial agent comprises zinc nitrate in an amount of from about 0.75 g to about 1.45 g per liter.

9. An antimicrobial agent according to claim 1, wherein the antimicrobial agent comprises gallium nitrate in an amount of from about 0.95 g to about 1.9 g per liter.

10. An antimicrobial agent according to claim 1 further comprising a solvent selected from the group consisting of water, alcohol, and combinations thereof.

11. A method of restricting or preventing bacterial growth comprising exposing the bacteria to an antimicrobial agent comprising:
nitric acid;
tetraethylorthosilicate;
tetraethyl phosphate;
zinc nitrate; and
gallium nitrate,
wherein the antimicrobial agent restricts or prevents the growth of the bacteria.

12. A method according to claim 11, wherein the bacteria is selected from the group consisting of: Actinomycetes, Nocardia, Salmonella, Staphylococcus, Enterobacter, Escherichia, and Bacillus.

13. A method according to claim 11, where the bacteria is Staphylococcus Aureus.

14. A method according to claim 11, wherein the bacteria is Enterobacter aerogenes.

15. A method according to claim 11, further comprising coating an article with the antimicrobial agent prior to exposing the bacteria to the antimicrobial agent.

16. A method according to claim 11, further comprising permeating an article with the antimicrobial agent prior to exposing the bacteria to the antimicrobial agent.

17. A method of restricting or preventing fungal growth comprising exposing the fungus to an antimicrobial agent comprising:
nitric acid;
tetraethylorthosilicate;
tetraethyl phosphate;
zinc nitrate; and
gallium nitrate,
wherein the antimicrobial agent restricts or prevents the growth of the fungus.

18. A method according to claim 17, wherein the fungus is selected from the group consisting of: Stachybotrys, Penicillium, Fusarium, Aspergillus, Candida, Paracoccidiodes, and Trycophyton.

19. A method according to claim 17, where the fungus is Candida albicans.

20. A method according to claim 17, wherein the fungus is Aspergillus flavus.

21. A method according to claim 17, further comprising coating an article with the antimicrobial agent prior to exposing the fungus to the antimicrobial agent.

22. A method according to claim 17, further comprising permeating an article with the antimicrobial agent prior to exposing the fungus to the antimicrobial agent.

23. An antimicrobial article of manufacture comprising:
nitric acid;
tetraethylorthosilicate;
tetraethyl phosphate;
zinc nitrate; and
gallium nitrate,
wherein the nitric acid, the tetraethylorthosilicate, the tetraethyl phosphate, the zinc nitrate, and the gallium nitrate are present in amounts sufficient to restrict or prevent the growth of at least one bacteria or at least one fungus.

24. An article of manufacture according to claim 23, wherein the article is selected from the group consisting of a container, a cutting board, a sponge, a fabric, a garment, a handle, a toy, a floor tile, an ointment, and a wound dressing.

25. An article of manufacture according to claim 23, wherein the nitric acid, the tetraethylorthosilicate, the tetraethyl phosphate, the zinc nitrate, and the gallium nitrate are present in amounts sufficient to restrict or prevent the growth of at least one bacteria and at least one fungus.

26. A method of restricting or preventing fungal growth on a seed comprising contacting the seed with an antimicrobial agent comprising:
nitric acid;
tetraethylorthosilicate;
tetraethyl phosphate;
zinc nitrate; and
gallium nitrate,
wherein the antimicrobial agent restricts or prevents the growth of the fungus.

27. A method according to claim 26, wherein the seed is the seed of a plant selected from the group consisting of barley, corn, wheat, oat, bean, soybean, pea, alfalfa, and peanut.

28. A method according to claim 26, wherein the contacting the seed with the antimicrobial agent further comprises spraying the antimicrobial agent on the seed.

29. A method according to claim 26, wherein the contacting the seed with the antimicrobial agent further comprises dipping the seed into the antimicrobial agent.

30. A method of making an antimicrobial article, the method comprising:
combining nitric acid, tetraethylorthosilicate, tetraethyl phosphate, zinc nitrate, gallium nitrate, and a solvent to form a solution;
mixing the solution under conditions that permit formation of a gel;
molding the gel into the shape of the article; and
dehydrating the gel to form the antimicrobial article.

31. A method according to claim 30 further comprising adding borane-tert-butylamine to the solution.

32. A method according to claim 30, wherein the solvent is selected from the group consisting of water, alcohol, and combinations thereof.

33. A method according to claim 30, wherein the dehydrating the gel further comprises lyophilizing or firing the gel.
